(19) United States
(12) Patent Application Publication
(10) Pub. No.: US 2004/0187662 A1
(43) Pub. Date: Sep. 30, 2004

(54) Piercing tool

(76) Inventors: Kurt Van Ulmer, Denver, CO (US); Michael D. Hennessey, Denver, CO (US); Sandra B. DeVore, Lakewood, CO (US); Cheryl Ann Stoughton, Denver, CO (US)

Correspondence Address: TIMOTHY J MARTIN, PC, 9250 W 5TH AVENUE, SUITE 200, LAKEWOOD, CO, 80226, US

(21) Appl. No.: 10/401,491

(22) Filed: Mar. 28, 2003

(51) Int. Cl. B26D 3/00

(52) U.S. Cl. 83/39; 30/314; 30/355

(57) ABSTRACT

A piercing tool to form a series of puncture marks in soft materials, such as pumpkins, is provided. The tool includes a handle, a working head, and a plurality of piercing elements, which may be formed as a one-piece plastic construction. The working head may be a flat blade terminating in an arcuate distal end with outwardly divergent side edges and an area of increased thickness to minimize lateral deflection of the blade while in use. The piercing elements project from the working head in a plane and may have a common height and configuration or include a primary tooth flanked by secondary teeth of a different height and configuration than the primary tooth. A method of forming a series of puncture marks is also provided and includes the steps of driving one piercing element into the material and advancing the tool to drive in an adjacent piercing element.

### FIELD OF INVENTION

The present invention is directed to a tool used for puncturing selected materials and a method for forming a series of puncture marks in the selected material. More particularly, the present invention is directed to a hand-held tool capable of transferring a desired pattern or image onto the surface of a vegetable, such as a pumpkin or watermelon.

### BACKGROUND OF THE INVENTION

Pumpkin carving has long been one of the several ways in which Halloween is celebrated. Traditionally, pumpkin carving first involves the removal of a portion of the pumpkin shell surrounding the stem and the removal of the seeds and fibers contained in the pumpkin. After the pumpkin is prepared, humorous, grotesque, or other decorative features may be carved partially or wholly through the pumpkin shell by removing fleshy portions of the shell to obtain the desired appearance. Internal illumination is then provided either by a candle or a battery operated light to result in a glowing decorative pattern.

In the past, pumpkin carving was typically accomplished with the use of pocketknives, paring knives, and the like. Sometimes, the image to be carved would be drawn on the pumpkin surface with a crayon or other writing instrument, or simply outlined with a knife before carving began. Accordingly, the artistic design carved into the pumpkin would depend upon the skill of the carver.

In order to improve both the tools used to carve pumpkins, as well as the designs carved into pumpkins, a pumpkin carving kit was developed and was described in U.S. Pat. No. 4,828,114 issued May 9, 1989 to John P. Bardeen (the “'114 Patent”). The kit described in the '114 Patent provides both simple and more elaborate patterns that may be transferred onto the surface of a pumpkin by poking small holes through the patterns and into the surface of the pumpkin. The tools provided with the kit, such as hand-held saws and drills, could then be used to cut the intricate features of the pattern through the shell of the pumpkin. Thus, the kit described in the '114 Patent made it possible for those having only basic artistic skills to carve very aesthetic and festive images into their pumpkins.

While the pumpkin carving kits exemplified by the '114 Patent have had wide commercial success and have greatly increased the enjoyment of the festive holiday for many people, these kits nonetheless have various associated drawbacks. One particular drawback is the way in which the patterns are transferred to the surface of the pumpkin. More specifically, the pumpkin carving kit instructs the pumpkin carver to poke small holes through the pattern sheets and into the surface of the pumpkin and recommends that these small holes be between 1/16″ to ⅛″ apart to best transfer the pattern.

Accordingly, the pumpkin carving kit is associated with a poker tool that is capable of forming these small holes. However, other tools such as hatpins or pushpins are also adequate to transfer these pumpkin patterns. The poker tool, hatpin, and pushpin are similarly configured in that each has a structure that allows for one small puncture hole to be made in the pumpkin's surface at a time. Further, each tool must be completely removed from the pumpkin surface in order to form an adjacent puncture hole.

Since a pattern is best transferred if the puncture holes are between 1/16″ to ⅛″ apart, even a simple pattern may require a large number of puncture holes to properly transfer the design. More intricate designs, on the other hand, may require an extraordinary number of puncture holes. Since the poker tool, hatpins, and pushpins can only form one puncture hole at a time, the repeated process of poking through the pattern and into the pumpkin, and then removing the tool before forming another hole, is slow and tedious. Furthermore, attempts to shortcut this process by forming holes that are too far apart oftentimes make the transferred pattern too difficult to carve properly.

Therefore, although the pumpkin carving kit described in the '114 Patent revolutionized pumpkin carving, there remains a need for an improved tool and method for transferring a pattern into the pumpkin shell that is faster and less tedious than using a poker tool, hatpin, or pushpin. The present invention is directed to meeting those needs.

### SUMMARY OF THE INVENTION

It is an object of the present invention to provide a new and useful tool for and method of forming a series of puncture marks in a selected material such as a pumpkin shell.

Another object of the present invention is to provide a tool capable of quickly transferring an image from a pattern sheet to a pumpkin that is less tedious and tiresome than using a hatpin, pushpin, or poker tool.

A further object of the present invention is to provide a tool that can form adjacent puncture holes without having to completely remove the tool from the surface of the pumpkin shell.

Yet another object of the present invention is to provide a tool that is capable of forming a plurality of puncture holes that are spaced close enough together for properly transferring a design from a pattern sheet to the pumpkin shell.

Still another object of the present invention is to provide a one-piece tool which is light-weight, easy and safe to use, and inexpensive to manufacture.

In accordance with these objectives, the present invention is directed to a tool comprising an elongated handle and a stationary working head having a plurality of piercing elements or teeth projecting therefrom. The handle extends longitudinally from a first handle end to a second handle end along a longitudinal axis or a tool axis. The handle may include at least one concavity but preferably a pair of oppositely disposed concavities formed therein.

The working head extends forwardly from a location proximate to the handle's second end to terminate in an arcuate distal end portion that extends transversely to the tool axis to define a working head plane. The arcuate distal end portion may have an angle of approximately 120 degrees. The working head may be formed as a flat blade terminating in a blade end surface such that the blade defines a blade plane. The working head may also include a pair of arcuate divergent side edges that extend forwardly of the handle such that the arcuate distal end portion extends therebetween. Further, the side edges may have a radius of curvature that is greater than that of the arcuate distal end portion.

The working head further includes at least two teeth disposed on the arcuate distal end portion and projecting in the working head plane for selected distance to define a respective tooth height. The tips of the teeth lie generally on the circumference of an imaginary circle having a center point located on the tool axis. These teeth are of a shape selected generally from pyramidal shapes and generally conical shapes and may be equidistantly spaced from one another. The teeth may include a primary tooth that is flanked on each lateral side by secondary teeth. The primary tooth may project from the arcuate distal end along the longitudinal axis and may have a cylindrical base portion and a conical tip. The secondary teeth, on the other hand, may project obliquely to the tool axis and may have a pyramidal configuration.

The handle and the working head each have a respective thickness, and as contemplated, the working head, or at least a portion thereof, may have a thickness that less than that of the handle. However, a proximal end portion of the working head may include an integral area of thickness that is approximately the same as that of the handle to form an area of reinforcement for minimizing lateral deflection of the working head. Further, the handle and working head may be symmetrical about the tool axis.

The present invention also contemplates a method of forming a series of puncture holes in a selected material. According to this method, a piercing tool that includes a plurality of piercing elements is provided. A first piercing element is then driven into the material to form an initial puncture hole, after which the tool is advanced in a first direction by partially removing the first piercing element so as to initiate contact between a first adjacent piercing element with the selected material, and then driving that adjacent element into the material.

The methodology may also incorporate the steps of advancing the tool further in the first direction to form a plurality of puncture holes as well as advancing the tool in a second direction, which is different from the first direction, to form a plurality of puncture holes. The methodology may further include the step of providing a pattern sheet with a pattern printed thereon, contacting the pattern sheet to the selected material, driving a first piercing element through the pattern sheet and into the selected material, and advancing the tool along the contours of the printed pattern so as to transfer the pattern into the selected material by way of forming a plurality of puncture holes.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of the piercing tool according to the present invention;

FIG. 2 is a perspective view of a pumpkin shown with a pattern sheet, the design of which is to be transferred using the piercing tool of the present invention;

FIG. 3 is a front view in elevation of the piercing tool according to the present invention;

FIG. 4 is a cross-sectional side view of the piercing tool taken along line 4-4 of FIG. 3;

FIG. 5 is a side view in elevation of the piercing tool of the present invention;

FIG. 6 is a front view in elevation of a portion of the working head portion of the piercing tool;

FIG. 7 is a perspective view of a portion of the pumpkin shell and pattern sheet of FIG. 2 showing how the piercing tool transfers the pattern to the pumpkin's surface; and

FIG. 8 is a front view in elevation of the piercing tool being held between a user's thumb and index finger.

### DETAILED DESCRIPTION OF THE EXEMPLARY EMBODIMENTS

The present invention relates to a new and useful tool and method of forming a series of puncture marks in the surface of a selected material. In particular, the present invention relates to a piercing tool especially capable of forming designs, or otherwise “transferring” designs, from a pattern sheet to an outer surface area of an item of produce, such as a pumpkin. As contemplated, the piercing tool broadly includes a handle and a working head with a plurality of piercing elements projecting therefrom that may be formed as a one-piece, plastic construction. However, as should be appreciated, the present invention is not limited to a one-piece construction. For example, the handle and the working head could be formed as two separate pieces that are joined together by any reasonable means as known in the art such as bolts, screws, nails, adhesives, and the like. Further, the piercing tool may be constructed from materials other than plastic, such as wood, metal, or a combination thereof. For example, the piercing tool may have a handle formed of wood and a working head formed of metal.

Since the tool of the present invention has particular utility for forming puncture marks in pumpkin shells, its features will be described herein in relation to decorating pumpkins for the Halloween season. However, it should be appreciated that the present tool may be used to form puncture marks in other materials that are soft enough to be punctured thereby. For example, the tool of the present invention may be used to puncture paper, cardboard, vegetables, or other fruits such as watermelons and the like.

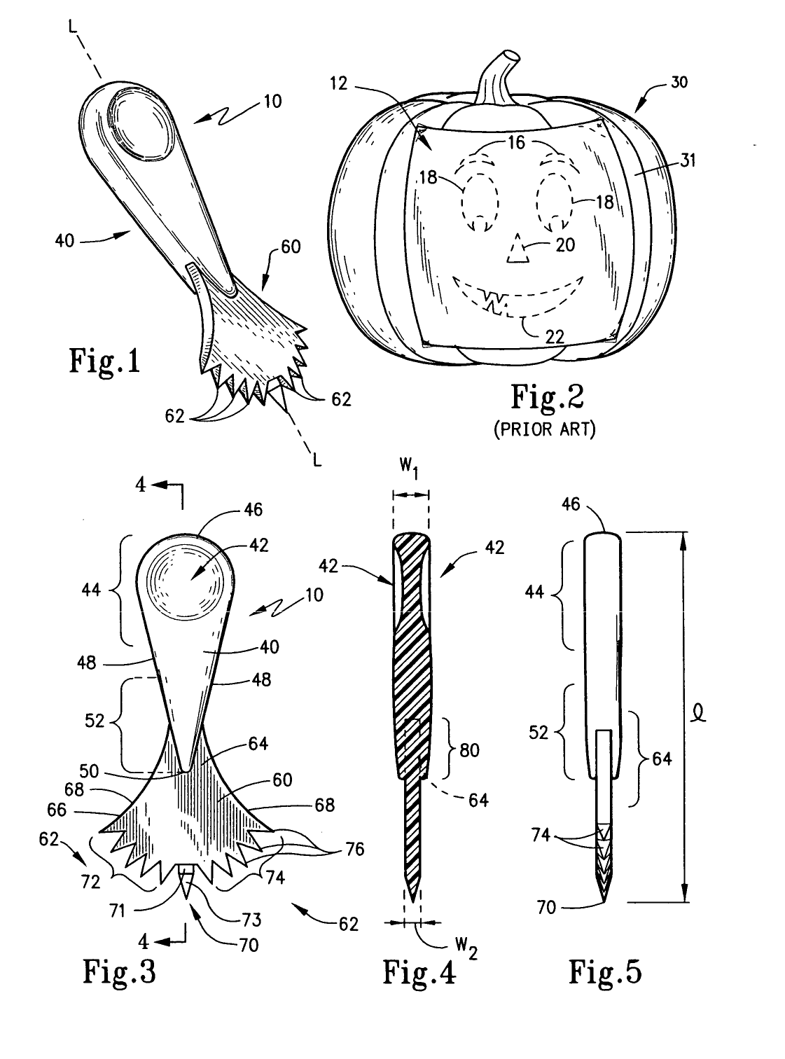

Before discussing the particular details of the present invention, it is perhaps helpful to first introduce some of its broad features. Turning then to FIG. 1, piercing tool 10 generally includes handle 40 and working head 60, which may be constructed as a single, integrally molded piece of plastic material by any convenient molding process, such as injection molding. Longitudinal tool axis “L” passes centrally through handle 40 and working head 60, and, as shown, piercing tool 10 is symmetrical about the longitudinal tool axis “L”. However, the piercing tool 10 need not be symmetrical to be useful.

Working head 60 includes a plurality of piercing elements 62 that are each capable of forming an individual puncture hole in the surface of a selected material. To appreciate the utility of a tool having a plurality of piercing elements, reference is now made to FIG. 2, which shows pumpkin 30 with pattern sheet 12 removably secured to a portion of its outer surface 31 as is known in the prior art. Pattern sheet 12 has a design printed thereon, including, for example, eyebrows 16, eyes 18, nose 20, and mouth 22.

Preferably, the design elements printed on pattern sheet 12 are first “transferred” to the pumpkin's outer surface 31 so that these features may be carved out of the pumpkin's shell. One way in which the design is transferred is by poking holes through the pattern sheet and into the pumpkin's surface. In the past, this would typically have been accomplished by using a hatpin, pushpin, or other tool capable of piercing through the pattern sheet and into the pumpkin's outer surface. The individually produced puncture holes formed in the pumpkin's outer surface provide the pattern by which the design may be carved out of the pumpkin shell.

Unfortunately, tools such as hatpins, pushpins, and the poker tool described in the Background of the Invention section above are only capable of forming one puncture hole at a time and, as such, must be completely removed from the pumpkin's outer surface to form an adjacent puncture hole. While use of single-hole forming tools of this nature adequately transfer the design to the pumpkin's surface, the transfer process is slow, tedious, and somewhat tiresome.

Piercing tool 10, introduced above with respect to FIG. 1, offers a more efficient and faster way of transferring patterns. As will become more apparent in the description below, piercing tool 10 is capable of forming a plurality of puncture holes by way of piercing elements 62 in a way that does not require the tool to be removed from the pumpkin's surface before each respective hole is formed. Further, as should be appreciated by the person ordinarily skilled in the art, the utility of the tool of the present invention is not limited to transferring patterns, as described above. Rather, it should be understood that the present tool may be used to form puncture holes directly into the surface of the pumpkin, or other selected material, without the need of a pattern sheet.

Having now described how the piercing tool of the present invention may be used to decorate exterior surfaces of selected items, the particular features of the tool, with reference to the preferred embodiment, may be described in more detail. Turning then to FIG. 3, handle 40 is generally configured to be teardrop in shape. Upper portion 44 of handle 40 includes a rounded first handle end 46 and extending therefrom are a pair of converging side edges 48 that terminate in a second rounded handle end 50 located at the lower portion 52 of handle 40. As should be understood, handle 40 is not limited to having a teardrop configuration. For example, the handle could be configured to be more conical in appearance so as to have a handle portion more similar to that of a screwdriver; naturally, other handle configurations would be suitable as well.

With reference to FIGS. 3 and 4, handle 40 includes a pair of concavities 42 formed in upper portion 44 thereof. Each concavity 42 is circular and may serve as a recess for a thumb or finger to allow the user to better maintain a grip on the tool during use. However, it is not necessary that handle 40 include concavity 42 in order to use piercing tool 10. Further, there are many ways in readily known in the art that to enhance the ability to grip a handle, such as handle 40 shown here. For example, handle 40 could include an upraised area in place of concavity 42. Alternatively, for example, handle 40 could be provided with rubber strips for helping the user maintain his/her grip.

As shown in FIG. 3, a working head 60 extends forwardly of handle 40 and is generally configured as a flat blade. Working head 60 includes a pair of arcuate side edges 68 that diverge forwardly of the handle from a proximal end portion 64 to terminate in an arcuate distal end 66, which extends transversely to the longitudinal tool axis “L” (shown in FIG. 1), and projecting therefrom is a plurality of piercing elements 62. As used herein, the word “transverse” or “transversely to” means lying across or situated cross-wise such that its meaning should not be limited to that having a perpendicular relationship. As will be appreciated, working blade 60 is not limited to the configuration shown in the figures. Rather, the present invention contemplates a working head configuration that is easy to manufacture, makes efficient use of packaging space, and, perhaps more importantly, is capable of having piercing elements 62 project therefrom.

With continued reference to FIG. 3, piercing elements 62 include a primary tooth 70, a first set of secondary teeth 72 and a second set of secondary teeth 74 located on a respective lateral side of the primary tooth. Primary tooth 70 projects from the arcuate distal end 66 along the longitudinal tool axis “L” whereas secondary teeth 72 and 74 project from arcuate distal end 66 at an angle that is oblique to the longitudinal tool axis “L”. Further, primary tooth 70 has both a different height and configuration than that of secondary teeth 72 and 74. More specifically, primary tooth 70 has a cylindrical base portion 71 and a conical tip portion 73 whereas secondary teeth 72 and 74 have a generally pyramidal configuration terminating in a triangular tip 76, which is perhaps best shown in FIG. 5.

Piercing elements 62 are not limited to having either a conical tip or a triangular tip as described above, but may be of any configuration suitable for piercing into the selected material. Moreover, the piercing tool is not limited to a construction wherein one primary tooth is flanked by a plurality of secondary teeth as shown in FIG. 3. Rather, the present invention also contemplates, for example, piercing elements formed as a plurality of primary teeth 70. In this instance, each of the primary teeth could project from the arcuate distal end 66 at a common height, or a centrally located primary tooth could project farther from the arcuate distal end similar to that shown in FIGS. 3 and 5. Alternatively, piercing tool 10 could have a construction wherein piercing elements 62 are formed as a plurality of secondary teeth 72, 74, which, again, may have either a common height, or include a centrally located tooth of a different height. As should also be understood by the person ordinarily skilled in the art, the size, number, spacing, and orientation of piercing elements 62 are not limited to that shown in the figures, but may be varied as desired or as needed for the purposes of the material selected, or design to be formed.

Turning now to FIGS. 4 and 5, it may be seen that handle 40 and working head 60 are formed as a single piece and that handle 40 is generally thicker than working head 60. Reinforcement area 80, which forms a portion of the working head, generally corresponds to lower portion 52 of the handle and proximal end portion 64 of the working head, as shown and described with respect to FIG. 3. It is preferred that reinforcement area 80 have a thickness that is somewhat greater than the overall thickness of the working head to minimize lateral deflection of the working head while it is being used. Further, as may be seen, reinforcement area 80 gently tapers from the overall thickness of handle 40.

With reference to both FIGS. 4 and 5, the entire length “I” of piercing tool 10, measured from first handle end 46 to the tip of primary tooth 70 may be between forty-five millimeters (45 mm) and seventy-five millimeters (75 mm), and is preferably about fifty-five millimeters (55 mm). The width “w₁” of handle 40, with the exception of reinforcement area 80, may be between three millimeters (3 mm) and ten millimeters (10 mm), and is preferably about six millimeters (6 mm), while the width “w₂” of the majority of working head 60 may be between two millimeters (2 mm) and four millimeters (4 mm), and is preferably about two and a half millimeters (2.5 mm). As should be understood, however, the measurements of piercing tool of the present invention need not be limited to the aforementioned ranges, but rather may be constructed of any length “I”, width “w₁”, and width “w₂” suitable for the needs of the user.

As mentioned in the beginning of the description, significant utility of the present invention is derived from the fact that it is capable of forming a plurality of puncture holes in a way that is faster and more efficient than using either a hatpin or a pushpin. Accordingly, it is necessary to not only describe the configuration of the piercing elements, but also to explain the interrelationship between these piercing elements and the way in which they project from the working head.

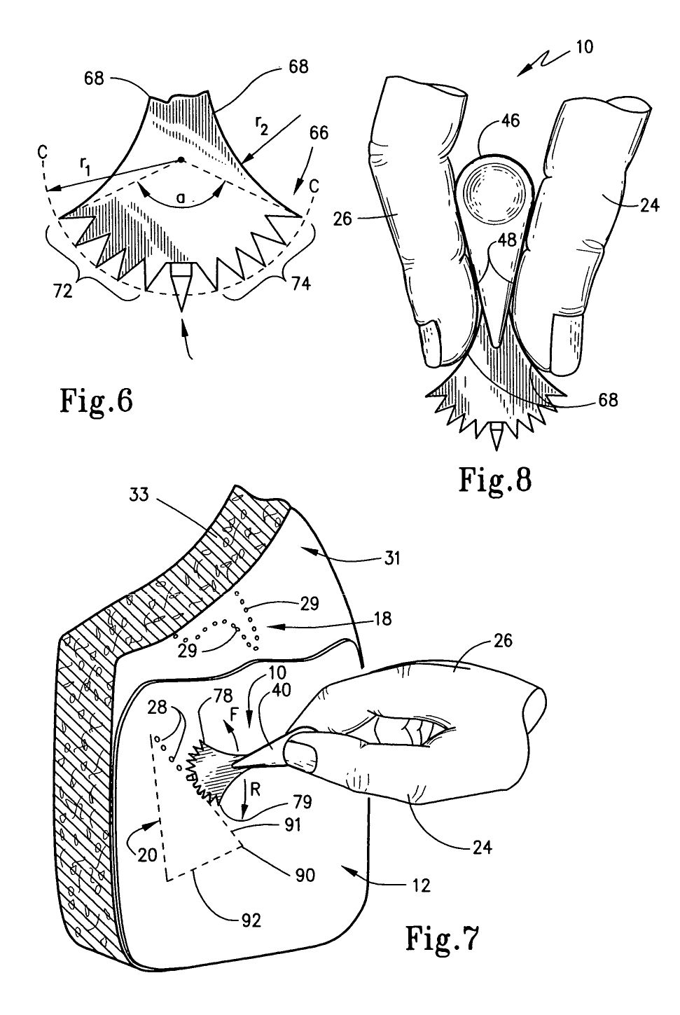

Turning then to FIG. 6, arcuate distal end 66 has an angle “a” of approximately 120°. Projecting therefrom is primary tooth 70, and two sets of secondary teeth 72 and 74. The tips of each of these teeth generally lie on the circumference of imaginary circle “C” having a radius “r₁” such that each tooth has generally the same height. Preferably, radius “r₁” is approximately equal to sixteen millimeters (16 mm). More particularly, as may be seen secondary teeth 72 and 74 have the same height while primary tooth 70 has a height that is somewhat greater than that of the secondary teeth. As a result, the tip of primary tooth 70 lies just beyond the circumference of circle “C”. In this way, the teeth project in an arcuate array. However, as should be understood by the person ordinarily skilled in the art, achieving an arcuate array of teeth need not only be accomplished by orienting the piercing elements on an arcuate distal end 66. For example, the distal end of working head 60 may be linear. Varying the heights of the piercing elements may then form an arcuate array of tips. Accordingly, the primary piercing element would, of course, have a height greater than that of each of the other piercing elements; each adjacent piercing element to the primary piercing element would have a second height and each adjacent secondary tooth thereto would have third height less than that of the second height and so on.

With continued reference to FIG. 6, arcuate, divergent side edges 68 have a radius of curvature r₂, which is greater than r₁. Preferably, radius of curvature r₂ is approximately thirty millimeters (30 mm). This difference in measurement contributes to the ability for each of the end teeth to puncture into the pumpkin's surface without being hindered, or obstructed by the side edges of the working head. While the configuration of arcuate side edges 68 maximizes the utility of this tool, it should be appreciated that side edges need not be arcuate or even divergent from one another in order for piercing tool 10 to be used as described above. For example, at least some or all of the piercing elements would be able to puncture the pumpkin's surface even if the working head included a pair of linear side edges extending forwardly of the handle.

With the above description in mind, the advancement of the tool from one tooth to the next can best be characterized as a rolling or rocking motion. This rolling characteristic is shown in FIG. 7, which shows handle 40 of piercing tool 10 squeezed between thumb 24 and index finger 26 and manipulated to form a series of puncture marks 28 along nose 20 to transfer the design into the pumpkin surface 31. As shown, piercing tool 10 is being “rolled” in the direction of path “R”, to form puncture marks 28 initiated by outer secondary tooth 78. Piercing tool 10 could, however, be rolled in the direction of “F” to form a series of puncture marks initiated by outer secondary tooth 79.

Alternatively, primary tooth 70 may be used to initiate the series of puncture marks such that the piercing tool may be advanced to drive an adjacent secondary tooth, either from set 72 or set 74, into the selected material. Primary tooth 70 also enables piercing tool 10 to be rotated on primary tooth 70 so as to change the direction in which the piercing tool is advanced. To further explain, if primary tooth 70 formed a puncture mark at corner 90 of the nose design, piercing tool 10 could next be advanced up side 91 of the design. Once each of the secondary teeth 72 have punctured through the pattern sheet along side 91, primary tooth 70 could be returned to the puncture mark it had previously formed in corner 90, and then rotated on its axis to align secondary teeth 72 or 74 to form puncture marks along the bottom 92 of the nose. In the event that only one puncture mark is needed, primary tooth 70 or secondary teeth 78 and 79 could be employed.

As shown, piercing tool 10 is able to be advanced from tooth to tooth without having to remove the entire tool from the pattern sheet. However the series of puncture marks are initiated, it should be understood that as the tool continues to advance or roll, an adjacent tooth is partially removed from its respective puncture mark while at the same time an adjacent puncture mark is being formed.

Ultimately, when the user has finished puncturing through all of the design elements on pattern sheet 12, it may be completely removed from the pumpkin's surface 31 to reveal a plurality of puncture marks formed therein. Specifically, as shown in FIG. 7, a portion of pattern sheet 12 is broken away to expose puncture marks 29 in the pumpkin's outer surface 31 that correspond to a portion of eye 18. Puncture marks 29 allow the pumpkin carver to next carve into the pumpkin shell to create the design.

Finally, FIG. 8 shows an alternative way in which piercing tool 10 may be gripped during use wherein both the converging teardrop configuration of handle 40, in combination with the arcuate divergent side edges 68 of the working head contribute to this alternative manner. Particularly, the rounded first handle end 46 and converging side edges 48 of the handle are contour to the shape of thumb 24 and finger 26, while arcuate divergent side edges 68 form a seat therefore.

Having discussed the construction of the piercing tool of the present invention, it should be readily appreciated that the present invention also contemplates a method of forming a series of puncture holes in a selected material. According to this method, a piercing tool that includes a plurality of piercing elements is provided. A first piercing element is then driven into the material to form an initial puncture hole, after which the tool is advanced in a first direction by partially removing the first piercing element so as to initiate contact between a first adjacent piercing element with the selected material, and then driving that adjacent element into the material.

The methodology may also incorporate the steps of advancing the tool further in the first direction to form a plurality of puncture holes as well as advancing the tool in a second direction, which is different from the first direction, to form a plurality of puncture holes. The methodology may further include the step of providing a pattern sheet with a pattern printed thereon, contacting the pattern sheet to the selected material, driving a first piercing element through the pattern sheet and into the selected material, and advancing the tool along the contours of the printed pattern so as to transfer the pattern into the selected material by way of forming a plurality of puncture holes.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

We claim:

1. A tool adapted to form a series of puncture marks in a selected material, comprising:
(A) an elongated handle extending longitudinally from a first handle end to a second handle end along a longitudinal axis;
(B) a stationary working head having a proximal end portion thereof supported by said handle and extending longitudinally from said second handle end to terminate in an arcuate distal end portion that extends transversely to the longitudinal axis such that the longitudinal axis and said arcuate distal end portion together generally define a working head plane; and
(C) at least two teeth disposed on said arcuate distal end portion and projecting in the working head plane for a selected distance to define a respective tooth height.

2. A tool according to claim 1 wherein said working head is formed as a flat blade.

3. A tool according to claim 1 wherein said working head includes a pair of side edges that extend forwardly of said handle in the working head plane, said arcuate distal end portion extending between said side edges.

4. A tool according to claim 3 wherein said side edges diverge outwardly from said handle along a respective arcuate path, said side edges having a radius of curvature that is greater than that of said arcuate distal end portion.

5. A tool according to claim 1 wherein said working head and said handle have a respective thickness and wherein a majority of said working head thickness is less than that of said handle.

6. A tool according to claim 5 wherein said proximal end portion of said working head includes an integral area of thickness that is approximately the same as that of said handle thereby forming an area of reinforcement for minimizing lateral deflection of said working head.

7. A tool according to claim 1 wherein said handle includes at least one concavity formed therein.

8. A tool according to claim 7 wherein said handle includes a pair of oppositely disposed concavities.

9. A tool according to claim 1 wherein said teeth are of a shape selected from generally pyramidal shapes and generally conical shapes.

10. A tool according to claim 1 wherein said teeth include at least one primary tooth having a first height and at least one secondary tooth having a height that is less than the first height.

11. A tool according to claim 10 wherein one primary tooth projects from said arcuate distal end along the longitudinal axis and wherein a plurality of secondary teeth flank each lateral side of said primary tooth.

12. A tool according to claim 11 wherein said primary tooth has a cylindrical base portion and a conical tip and wherein said secondary teeth are generally pyramidal.

13. A tool according to claim 1 wherein said handle, said working head, and said teeth are molded as an integral one-piece plastic construction.

14. A tool adapted to form a series of puncture marks in a selected material, comprising:
(A) an elongated handle portion extending longitudinally from a first handle end to a second handle end along a tool axis;
(B) a flat blade portion that is supported by said handle portion and extending forwardly of said handle portion from a location proximate to said second handle end along the tool axis and terminating in a blade end surface, said blade portion defining a blade plane; and
(C) a plurality of piercing elements forwardly projecting from said blade end surface in the blade plane at a selected distance wherein each of said piercing elements terminates in a tip that lies generally on the circumference of an imaginary circle having a center point located on the tool axis including at least two piercing elements having respective configurations that are different from one another.

15. A tool according to claim 14 wherein said blade end surface is arcuate.

16. A tool according to claim 15 wherein said arcuate blade end surface has an angle of approximately 120°.

17. A tool according to claim 14 wherein the tips of said piercing elements are of a shape selected from generally pyramidal shapes and generally conical shapes.

18. A tool according to claim 14 wherein said piercing elements include
(A) at least one primary piercing element having a first height and a conical tip; and
(B) at least one secondary piercing element having a height that is less than the first height and having a pyramidal tip.

19. A tool according to claim 18 wherein one of said primary piercing elements is oriented on the tool axis and wherein a plurality of said secondary piercing elements project obliquely to the tool axis.

20. A tool according to claim 14 wherein said piercing elements are generally equidistantly spaced from one another.

21. A tool according to claim 14 wherein said handle portion and said blade portion are each symmetrical about the tool axis.

22. A method of forming a series of puncture marks in a selected material, comprising:
(A) providing a piercing tool that includes a plurality of piercing elements;
(B) driving a first one of said piercing elements into said selected material to form an initial puncture hole;
(C) advancing said piercing tool in a first direction by partially removing said first piercing element and initiating contact of a first adjacent piercing element with said selected material;
(D) further advancing said piercing tool in the first direction to drive said first adjacent piercing element into said selected material to form a first adjacent puncture hole.

23. A method according to claim 22 including the step of advancing said piercing tool in the first direction to form a plurality puncture holes linearly aligned with said second puncture hole.

24. A method according to claim 22 including the step of returning said first piercing element wholly within said first puncture hole and then advancing said piercing tool in a second direction, which is different from said first direction, to drive a second adjacent piercing element into said selected material to form a second adjacent puncture hole.

25. A method according to claim 22 further including the steps of:
(A) providing a pattern sheet with a pattern printed thereon;
(B) contacting said pattern sheet with said selected material;
(C) driving said first piercing element through said pattern sheet and into said selected material; and
(D) advancing said piercing tool along the contours of said printed pattern to form a plurality of puncture holes so as to transfer said pattern into said selected material.
